(19) United States
(12) Patent Application Publication
(10) Pub. No.: US 2024/0386135 A1
(43) Pub. Date: Nov. 21, 2024

(54) DISCLOSED-MATERIAL-CONCEALING DEVICE, DISCLOSED-MATERIAL-CONCEALING METHOD, AND RECORDING MEDIUM STORING DISCLOSED-MATERIAL-CONCEALING PROGRAM

(71) Applicant: NEC Corporation, Minato-ku, Tokyo (JP)

(72) Inventor: Yasuo IIMURA, Tokyo (JP)

(73) Assignee: NEC Corporation, Minato-ku, Tokyo (JP)

(21) Appl. No.: 18/694,493

(22) PCT Filed: Jan. 25, 2022
(86) PCT No.: PCT/JP2022/002539

§ 371 Date: Mar. 22, 2024

(30) Foreign Application Priority Data
Feb. 8, 2021 (JP) 2021-176074

(51) Int. Cl. G06F 21/62

(52) U.S. Cl. CPC G06F 21/6245

(57) ABSTRACT

A disclosed-material-concealing device comprises: an extraction unit that extracts a phrase from original material to be disclosed; a determination unit that determines whether or not to perform a concealing process on the phrase on the basis of an attribute of the extracted phrase, an attribute of the disclosure destination of the original material to be disclosed, and a concealment reference; and a generation unit that generates post-concealing-process material to be disclosed, which is the result of performing the concealing process on the phrase determined to undergo the concealing process. The concealment reference represents the relationship between the attribute of the phrase, the attribute of the disclosure destination, and the necessity of performing the concealing process, whereby a certain phrase included in the material to be disclosed to a disclosure requester is accurately concealed with high precision in light of the relationship between the information and the disclosure requester.

### TECHNICAL FIELD

The present invention relates to a disclosed-material-concealing device, a disclosed-material-concealing method, and a disclosed-material-concealing program.

### BACKGROUND ART

For example, in a trial of a certain case, there is a case where the assailant side desires to view a material related to the victim side or the victim side desires to view a material related to the assailant side. In this case, in the material, information (e.g., personal information etc.) that is not desired to be known to the disclosure (browsing) requesting side is concealed by being blackened (masked) on the plane of drawing and provided to the disclosure requesting side. A technology for supporting the process of concealing information that is not desired to be known to the disclosure requesting side included in the disclosed material for the disclosure requesting side is expected.

In relation to such a technique, PTL 1 discloses a document processing method for detecting a masking target portion from an input document based on a word dictionary that stores a character string to be masked or a part of a character string to be masked. In this method, the detected masking target portion is stored in a masking result list, and the masking target portion stored in the masking result list is displayed on the display screen. In this method, when any one of the displayed masking target portions is corrected by the user, the masking target portion stored in the masking result list is rewritten to the masking target portion corrected by the user. In this method, the masking target portion in the document is masked based on the rewritten masking target portion stored in the masking result list.

In addition, PTL 2 discloses a unique expression extraction method that adopts a method of sequentially learning an extraction rule of when extracting a unique expression from a document and presents a candidate to be teacher data to a worker. In this method, in the discrimination of the unique expression candidate, reference materials related to the candidate are presented to the worker to support the discrimination.

In addition, PTL 3 discloses a learning system in which learning of laws and the like can be learned according to the level of a learner and which can also be used for the convenience of practitioners engaged in jobs related to laws and the like. In this system, a plurality of mutually similar articles and a comparison between the articles are instructed by a comparison article button. When the comparison between the articles is instructed by the comparison article button, the system extracts the article and enables the extracted article to be compared.

### CITATION LIST

### Patent Literature

PTL 1: JP 2004-227141 A
PTL 2: JP 2006-023968 A
PTL 3: JP 2012-027491 A

### SUMMARY OF INVENTION

### Technical Problem

The criterion for determining whether to conceal a certain phrase (character string) included in the material to be disclosed to the disclosure requesting side is not a simple criterion such as concealing all for example, for personal information. For example, even in the case of personal information included in the disclosed material, it is usually not necessary to conceal the personal information (e.g., personal information of the disclosure requesting side him/herself, personal information of a person having a deep human relationship with the disclosure requesting side, or the like) in which the personal information is obvious to the disclosure requesting side. In a case where concealment is performed more than necessary in the disclosed document, the material becomes a material difficult to understand for the disclosure requesting side. Furthermore, from the relationship between the information included in the disclosed material and the disclosure requesting side, in a case where concealment of a phrase that should be concealed is not performed due to a determination error or the like, information that is not desired to be known to the disclosure requesting side leaks. From the above, it is an object to accurately conceal a certain phrase included in the material to be disclosed to the disclosure requesting side with high accuracy based on the relationship between the information and the disclosure requesting side. PTLs 1 to 3 do not mention this problem.

A main object of the present invention is to accurately conceal a phrase included in material to be disclosed to a disclosure requesting side with high accuracy based on a relationship between the information and the disclosure requesting side.

### Solution to Problem

A disclosed-material-concealing device according to one aspect of the present invention includes an extraction means that extracts a phrase from original disclosure target material; a determination means that determines whether to perform a concealing process on the phrase based on an attribute of the extracted phrase, an attribute of a disclosure destination of the original disclosure target material, and a concealment criterion; and a generation means that generates a disclosure target material after the concealing process in which the concealing process has been performed on the phrase determined to be subjected to the concealing process:
wherein the concealment criterion represents a relationship among an attribute of the phrase, an attribute of the disclosure destination, and necessity of performing the concealing process.

In another standpoint for achieving the above object, a disclosed-material-concealing method according to one aspect of the present invention is a method by an information processing device of extracting a phrase from original disclosure target material, determining whether to perform a concealing process on the phrase based on attribute of the extracted phrase, attribute of a disclosure destination of the original disclosure target material, and a concealment criterion, and generating a disclosure target material after the concealing process in which the concealing process has been performed on the phrase determined to be subjected to the concealing process: wherein the concealment criterion represents a relationship among an attribute of the phrase, an attribute of the disclosure destination, and necessity of performing the concealing process.

Furthermore, in another further standpoint for achieving the above object, a disclosed-material-concealing program according to one aspect of the present invention is a program for causing a computer to execute an extraction process of extracting a phrase from original disclosure target material, a determination process of determining whether to perform a concealing process on the phrase based on attribute of the extracted phrase, attribute of a disclosure destination of the original disclosure target material, and a concealment criterion, and a generation process of generating a disclosure target material after the concealing process in which the concealing process has been performed on the phrase determined to be subjected to the concealing process: wherein the concealment criterion represents a relationship among an attribute of the phrase, an attribute of the disclosure destination, and necessity of performing the concealing process.

Furthermore, the present invention can also be achieved by a computer-readable non-volatile recording medium in which the disclosed-material-concealing program (computer program) is stored.

### Advantageous Effects of Invention

According to the present invention, a disclosed-material-concealing device or the like is obtained that accurately conceals a phrase included in a material to be disclosed to a disclosure requesting side with high accuracy based on a relationship between the information and the disclosure requesting side.

### BRIEF DESCRIPTION OF DRAWINGS

FIG. 1 is a block diagram illustrating a configuration of a disclosed-material-concealing device 10 according to a first example embodiment of the present invention.

FIG. 2 is a diagram illustrating a configuration of an original disclosure target material 101 and a disclosure target material 164 after concealing process according to the first example embodiment of the present invention.

FIG. 3A is a flowchart (1/2) illustrating an operation (process) of the disclosed-material-concealing device 10 according to the first example embodiment of the present invention.

FIG. 3B is a flowchart (2/2) illustrating an operation (process) of the disclosed-material-concealing device 10 according to the first example embodiment of the present invention.

FIG. 4 is a block diagram illustrating a configuration of a disclosed-material-concealing device 30 according to a second example embodiment of the present invention.

FIG. 5 is a block diagram illustrating a configuration of an information processing device 900 capable of achieving the disclosed-material-concealing device 10 according to the first example embodiment or the disclosed-material-concealing device 30 according to the second example embodiment of the present invention.

### EXAMPLE EMBODIMENT

Hereinafter, example embodiments of the present invention will be described in detail with reference to the drawings.

### First Example Embodiment

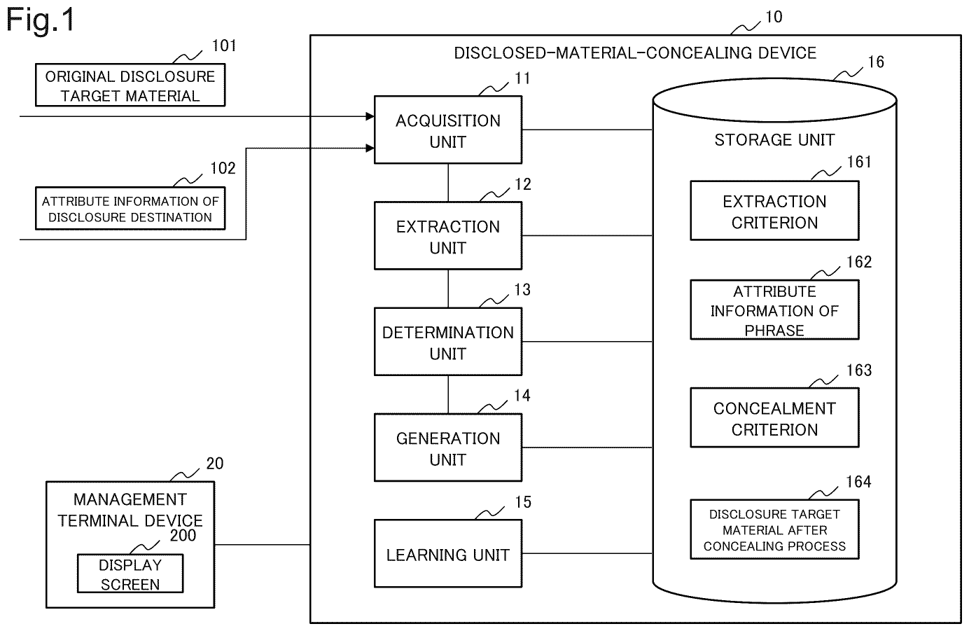

FIG. 1 is a block diagram illustrating a configuration of a disclosed-material-concealing device 10 according to a first example embodiment of the present invention. The disclosed-material-concealing device 10 is a device that generates a disclosure target material 164 after a concealing process in which some phrases (character strings) included in an original disclosure target material 101 for which the disclosure (browsing) request has been made are concealed.

A management terminal device 20 is communicably connected to the disclosed-material-concealing device 10. The management terminal device 20 is, for example, a personal computer or another information processing device used when a user who uses the disclosed-material-concealing device 10 inputs information to the disclosed-material-concealing device 10 or confirms information output from the disclosed-material-concealing device 10. The management terminal device 20 includes a display screen 200 that displays the information output from the disclosed-material-concealing device 10.

The disclosed-material-concealing device 10 includes an acquisition unit 11, an extraction unit 12, a determination unit 13, a generation unit 14, a learning unit 15, and a storage unit 16. The extraction unit 12, the determination unit 13, the generation unit 14, and the learning unit 15 are examples of an extraction means, a determination means, a generation means, and a learning means in order.

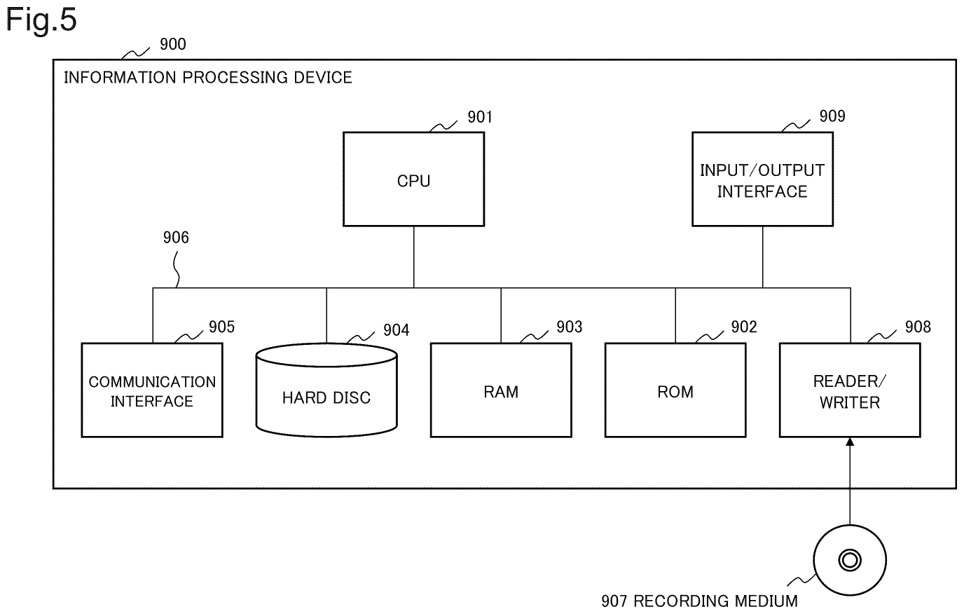

The storage unit 16 is, for example, a storage device such as a random access memory (RAM) or a hard disk 904 described later with reference to FIG. 5. The storage unit 16 stores extraction criterion 161, attribute information 162 of a phrase, concealment criterion 163, and disclosure target material 164 after the concealing process. Details of these pieces of information stored in the storage unit 16 will be described later.

For example, the acquisition unit 11 acquires the original disclosure target material 101 and the attribute information 102 of the disclosure destination from an external device (not illustrated) according to an instruction of a user who performed an input operation on the management terminal device 20.

The original disclosure target material 101 is, for example, a material requested to be disclosed (browsed) by the assailant side regarding the victim side or by the victim side regarding the assailant side in a trial of a certain case. Alternatively, the original disclosure target material 101 is, for example, a material that mass communication discloses as an article regarding a certain case or the like. Alternatively, the original disclosure target material 101 is, for example, a material that is created by a certain department in an organization (company, government office, etc.) and requested to be disclosed by another department in the organization or an institution outside the organization (police, mass communication, etc.). The original disclosure target material 101 may be a material requested to be disclosed in a case different from the foregoing case.

The attribute information 102 of the disclosure destination is information representing the attribute of a person or an organization who has requested the disclosure of the original disclosure target material 101. In the present example embodiment, a person or an organization who has requested the disclosure (browsing) of the original disclosure target material 101 will be hereinafter referred to as a disclosure destination.

The attribute information 102 of the disclosure destination represents, for example, a human relationship of the disclosure destination with respect to a person described in the original disclosure target material 101. More specifically, the human relationship indicates, for example, at least one of a family member, a relative, a friend, a workplace being the same (i.e., a superior, a colleague, a subordinate, or the like in a workplace), and no acquaintance.

Alternatively, the attribute information 102 of the disclosure destination represents, for example, a business relationship of the disclosure destination with respect to a creating department that has created the original disclosure target material 101. More specifically, the business relationship indicates, for example, the outside or the inside of an organization (company, government office, etc.) to which the creating department belongs.

The acquisition unit 11 inputs the acquired original disclosure target material 101 to the extraction unit 12, and inputs the attribute information 102 of the disclosure destination to the determination unit 13. The acquisition unit 11 may store the original disclosure target material 101 and the attribute information 102 of the disclosure destination in the storage unit 16.

The extraction unit 12 extracts a phrase (character string) from the original disclosure target material 101 acquired by the acquisition unit 11 based on the extraction criterion 161. However, the extraction criterion 161 is a criterion used when a phrase is extracted from a sentence using a syntax analysis technique. Since the syntax analysis technique is a well-known technique, a detailed description thereof will be omitted in the present example embodiment.

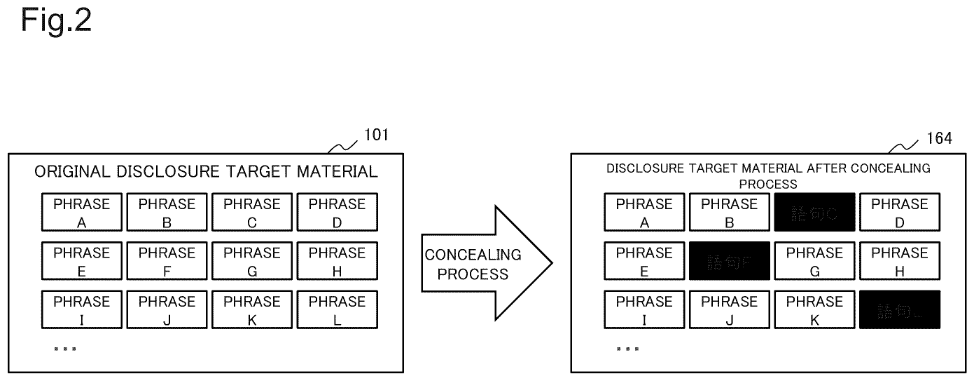

FIG. 2 is a diagram illustrating a configuration of the original disclosure target material 101 and the disclosure target material 164 after concealing process according to the present example embodiment. As illustrated in FIG. 2, the extraction unit 12 extracts phrases including phrases A to L from the original disclosure target material 101 as described above. At this time, the extraction unit 12 may also extract position information of each phrase in the original disclosure target material 101 (e.g., coordinates of each phrase in the original disclosure target material 101 represented as a plane of drawing).

The extraction unit 12 inputs a result of extracting a phrase from the original disclosure target material 101 to the determination unit 13. The extraction unit 12 may store a result of extracting a phrase from the original disclosure target material 101 in the storage unit 16.

The determination unit 13 determines whether to perform the concealing process on each extracted phrase based on the attribute information 162 of the phrase related to the phrase extracted by the extraction unit 12, the attribute information 102 of the disclosure destination acquired by the acquisition unit 11, and the concealment criterion 163. However, the concealment criterion 163 is a criterion representing the relationship among the attribute of the extracted phrase, the attribute of the disclosure destination, and the necessity of performing the concealing process.

The attribute information 162 of the phrase indicates, for example, the type of personal information. More specifically, the type of the personal information indicates, for example, at least one of a person's name, an age, an address, a contact information (e.g., a telephone number or an e-mail address), an account number of a financial institution, a credit card number, a pension number, a resident record code, an Individual Number, a license number, a vehicle number of an automobile, an insurance card number, a passport number, and the like. The type of the personal information is not limited to that described above.

Alternatively, the attribute information 162 of the phrase indicates, for example, the type of the organization information or the degree of confidentiality. More specifically, the type of the organization information indicates, for example, any of an organization name, a location of an organization, a contact information, and the like. Furthermore, more specifically, the degree of the confidentiality indicates, for example, organization secret or secret among authorized persons. The type of the organization information and the degree of the confidentiality are not limited to those described above.

Alternatively, the attribute information 162 of the phrase indicates, for example, date and time. For example, in some cases, it is necessary to conceal the date and time when the original disclosure target material 101 was created described in the original disclosure target material 101.

For example, in a trial of a certain case, it is assumed that the attribute information 162 of the phrase indicates “contact information” for a certain phrase extracted from the original disclosure target material 101 for which a request for disclosure was made from the victim side or the assailant side. It is assumed that the attribute information 102 of the disclosure destination is “no acquaintance”. In this case, it is not preferable that the information of the “contact information” be known to the other party between the victim and the assailant who are originally not acquaintances, and thus, the concealment criterion 163 represents to conceal the phrase.

For example, in a trial of a certain case, it is assumed that the attribute information 162 of the phrase indicates “person's name” for a certain phrase extracted from the original disclosure target material 101 for which a request for disclosure was made from the victim side or the assailant side. It is assumed that the attribute information 102 of the disclosure destination is “the workplace is the same”. In this case, since the name of the other party is known between the victim and the assailant and there is no need to conceal the phrase, the concealment criterion 163 represents not to conceal the phrase.

For example, it is assumed that the attribute information 162 of the phrase indicates “company secret (organization secret)” for a certain phrase extracted from the original disclosure target material 101 created by a certain department in a company. Then, it is assumed that the attribute information 102 of the disclosure destination indicates “outside the company”. In this case, since the information of company secret cannot be disclosed to the outside of the company, the concealment criterion 163 represents to conceal the phrase. In addition, in a case where the attribute information 162 of a phrase indicates “company secret”, and the attribute information 102 of the disclosure destination indicates “within company”, the information of the company secret can be disclosed to within the company, and thus the concealment criterion 163 represents not to conceal the phrase.

In a case where original disclosure target material 101 related to a certain person is disclosed to the disclosure destination, since the personal information is generally known to each other the deeper the human relationship between the person and the disclosure destination, the concealment criterion 163 shows a tendency to reduce the concealment target the deeper the human relationship.

Furthermore, in a case where a mass communication or the like discloses an original disclosure target material 101 related to a certain case or event as an article, there is more well-known information regarding a famous person than an ordinary person. Therefore, the concealment criterion 163 shows a tendency to reduce the concealment target in the case where the attribute information 162 of the phrase is information of a famous person than in the case where the attribute information 162 of the phrase is information of an ordinary person.

Furthermore, the concealment criterion 163 represents a relationship between the attribute information 102 of the disclosure destination and the attribute information 162 of the phrase generally represented as a multidimensional vector, and the necessity of performing the phrase concealing process. The concealment criterion 163 may be, for example, a rule-based criterion created by the user. Alternatively, the concealment criterion 163 may be, for example, a learning model generated or updated by learning by the learning unit 15 to be described later. In that case, the concealment criterion 163 is a learning model in which the attribute information 102 of the disclosure destination and the attribute information 162 of the phrase are used as explanatory variables and the necessity of performing the phrase concealing process is used as an objective variable.

The determination unit 13 inputs a determination result as to whether to perform the concealing process regarding each extracted phrase to the generation unit 14.

The generation unit 14 generates the disclosure target material 164 after the concealing process in which the concealing process has been performed on each phrase based on the determination result regarding each phrase input from the determination unit 13. In the example illustrated in FIG. 2, the generation unit 14 generates the disclosure target material 164 after the concealing process in which the concealing process has been performed on the phrase C, the phrase F, and the phrase L determined as the target of concealment by the determination unit 13.

As illustrated in FIG. 2, the generation unit 14 may perform a process of blacking out the phrases subjected to the concealing process so as not to be visible in the disclosure target material 164 after the concealing process displayed on the display screen 200 or printed on the paper by a printing device (not illustrated). At this time, the generation unit 14 may specify the position to be blacked out using the position information of each phrase in the original disclosure target material 101 extracted by the extraction unit 12 (such as coordinates of each phrase in the original disclosure target material 101 represented as a plane of drawing).

Alternatively, the generation unit 14 may perform the concealing process by abstracting a phrase that is a proper noun to be concealed, for example, a person A and a place B. However, in this case, a criterion (not illustrated) for abstracting the proper nouns is stored in the storage unit 16 in advance, and the generation unit 14 abstracts the proper noun using the criterion.

The learning unit 15 generates or updates the concealment criterion 163 by learning the relationship among the attribute information 162 of the phrase, the attribute information 102 of the disclosure destination, and the necessity of performing the phrase concealing process.

For example, in the example illustrated in FIG. 2, it is assumed that the user desires the disclosure target material 164 after the concealing process in which the phrase C, the phrase F, and the phrase L are concealed, but the concealing of the phrase F is not performed in the disclosure target material 164 after the concealing process generated by the disclosed-material-concealing device 10. In this case, the user can confirm that the concealment with respect to the phrase F is not performed in the disclosure target material 164 after the concealing process displayed on the display screen 200 of the management terminal device 20. Then, the management terminal device 20 accepts an input operation by the user to correct the disclosure target material 164 after the concealing process in such a way as to conceal the phrase F.

In the above case, the concealment of the phrase F is not performed because there is a possibility that the attribute of the phrase F indicated by the attribute information 162 of the phrase is incorrect or unregistered. The user checks the attribute of the phrase F on the menu screen for checking and updating the attribute information 162 of the phrase displayed on the display screen 200. Then, in a case where update of the attribute of the phrase F is necessary, the management terminal device 20 accepts an input operation by the user who updates the attribute of the phrase F in the attribute information 162 of the phrase.

The learning unit 15 receives the information indicating the input operation by the user from the management terminal device 20, and updates the disclosure target material 164 after the concealing process and the attribute information 162 of the phrase. The learning unit 15 generates or updates the concealment criterion 163 by performing learning using the attribute information 102 of the disclosure destination, the attribute information 162 of the phrase updated as described above, and the disclosure target material 164 after the concealing process as teacher data.

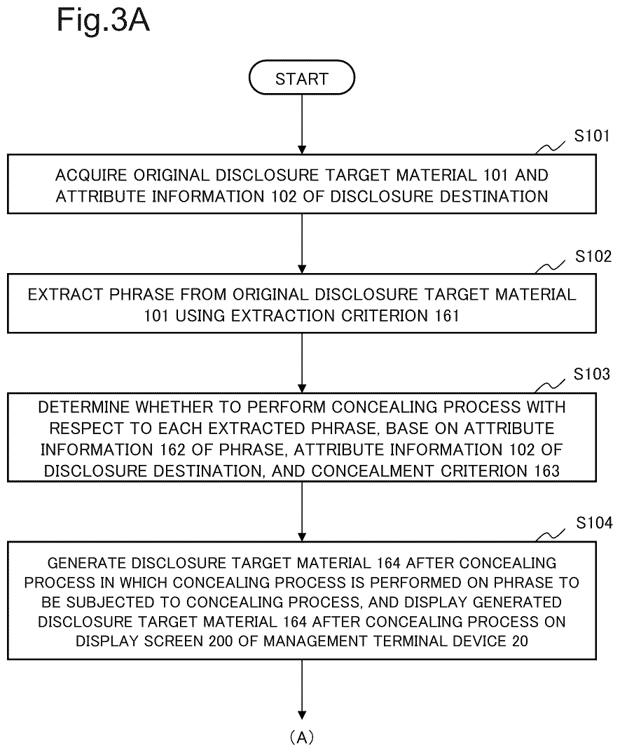

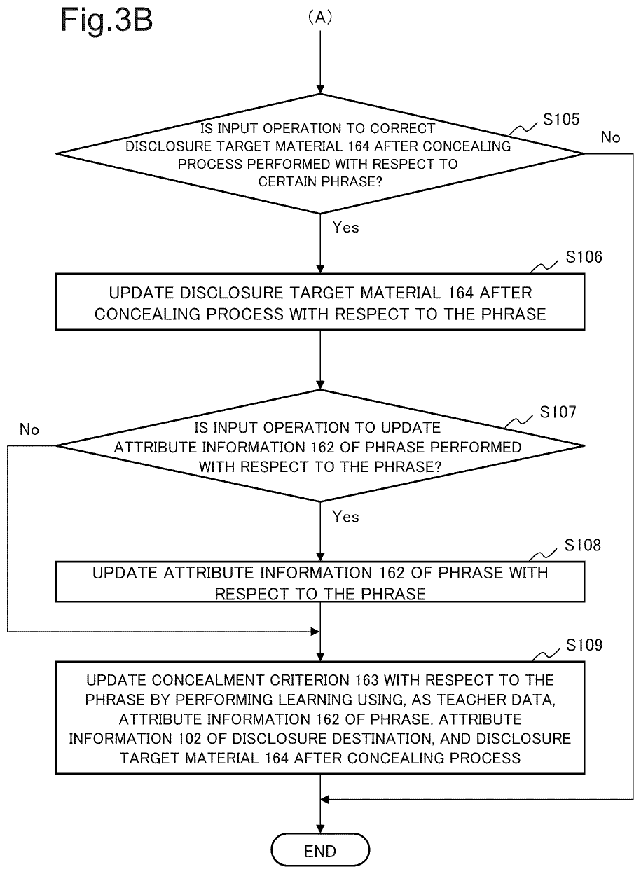

Next, operation (process) of the disclosed-material-concealing device 10 according to the present example embodiment will be described in detail with reference to flowcharts of FIGS. 3A and 3B.

The acquisition unit 11 acquires the original disclosure target material 101 and the attribute information 102 of the disclosure destination from an external device (step S101). The extraction unit 12 extracts a phrase from the original disclosure target material 101 acquired by the acquisition unit 11 by using the extraction criterion 161 (step S102). The determination unit 13 determines whether to perform the concealing process for each phrase extracted by the extraction unit 12 based on the attribute information 162 of the phrase, the attribute information 102 of the disclosure destination, and the concealment criterion 163 (step S103).

The generation unit 14 generates the disclosure target material 164 after the concealing process in which the concealing process has been performed on the phrase to be subjected to the concealing process in the determination by the determination unit 13, and displays the generated disclosure target material 164 after the concealing process on the display screen 200 of the management terminal device 20 (step S104).

In the management terminal device 20, in a case where the user does not perform the input operation to correct the disclosure target material 164 after the concealing process with respect to a certain phrase (No in step S105), the entire process ends. In the management terminal device 20, in a case where the user performs an input operation to correct the disclosure target material 164 after the concealing process with respect to a certain phrase (Yes in step S105), the learning unit 15 updates the disclosure target material 164 after the concealing process with respect to the phrase (step S106).

In the management terminal device 20, when the input operation of updating the attribute information 162 of the phrase is not performed with respect to the phrase (No in step S107), the process proceeds to step S109. In the management terminal device 20, when an input operation of updating the attribute information 162 of the phrase is performed with respect to the phrase (Yes in step S107), the learning unit 15 updates the attribute information 162 of the phrase with respect to the phrase (step S108).

With respect to the phrase, the learning unit 15 updates the concealment criterion 163 by performing learning using the attribute information 162 of the phrase, the attribute information 102 of the disclosure destination, and the disclosure target material 164 after the concealing process as teacher data (step S109), and the entire process ends.

The disclosed-material-concealing device 10 according to the present example embodiment can accurately conceal a certain phrase included in the material disclosed to the disclosure requesting side with high accuracy based on the relationship between the information and the disclosure requesting side. The reason therefor is that the disclosed-material-concealing device 10 conceals a phrase included in the material by using a concealment criterion 163 indicating a relationship among an attribute of a phrase included in the material, an attribute of a disclosure destination, and a necessity of performing the concealing process.

Hereinafter, effects achieved by the disclosed-material-concealing device 10 according to the present example embodiment will be described in detail.

The criterion for determining whether to conceal a certain phrase (character string) included in the material to be disclosed to the disclosure requesting side is not a simple criterion such as concealing all for example, for personal information. For example, even in the case of personal information included in the disclosed material, it is usually not necessary to conceal the personal information (e.g., personal information of the disclosure requesting side him/herself, personal information of a person having a deep human relationship with the disclosure requesting side, or the like) in which the personal information is obvious to the disclosure requesting side. In a case where concealment is performed more than necessary in the disclosed document, the material becomes a material difficult to understand for the disclosure requesting side. Furthermore, from the relationship between the information included in the disclosed material and the disclosure requesting side, in a case where concealment of a phrase that should be concealed is not performed due to a determination error or the like, information that is not desired to be known to the disclosure requesting side leaks. From the above, it is an object to accurately conceal a certain phrase included in the material to be disclosed to the disclosure requesting side with high accuracy based on the relationship between the information and the disclosure requesting side.

In view of such a problem, the disclosed-material-concealing device 10 according to the present example embodiment includes the extraction unit 12, the determination unit 13, and the generation unit 14, and for example, operates as described above with reference to FIGS. 1 to 3B. That is, the extraction unit 12 extracts a phrase from the original disclosure target material 101. The determination unit 13 determines whether to perform the concealing process on the phrase based on the attribute information 162 of the phrase indicating the attribute of the extracted phrase, the attribute information 102 of the disclosure destination indicating the attribute of the disclosure destination of the original disclosure target material 101, and the concealment criterion 163. However, the concealment criterion 163 indicates a relationship among the attribute information 162 of the phrase, the attribute information 102 of the disclosure destination, and the necessity of performing the concealing process. Then, the generation unit 14 generates the disclosure target material 164 after the concealing process in which the concealing process has been performed on the phrase determined to be subjected to the concealing process. As a result, the disclosed-material-concealing device 10 can accurately conceal a certain phrase included in the material disclosed to the disclosure requesting side with high accuracy based on the relationship between the information and the disclosure requesting side.

Furthermore, the disclosed-material-concealing device 10 according to the present example embodiment further includes the learning unit 15 that generates or updates the concealment criterion 163 by learning the relationship among the attribute information 162 of the phrase, the attribute information 102 of the disclosure destination, and the necessity of performing the concealing process. Then, the learning unit 15 generates or updates the concealment criterion 163 by accepting an input operation by the user who updates the attribute information 162 of the phrase. As a result, the disclosed-material-concealing device 10 can enhance the accuracy of concealing a phrase included in the material disclosed to the disclosure requesting side based on the relationship between the information and the disclosure requesting side.

### Second Example Embodiment

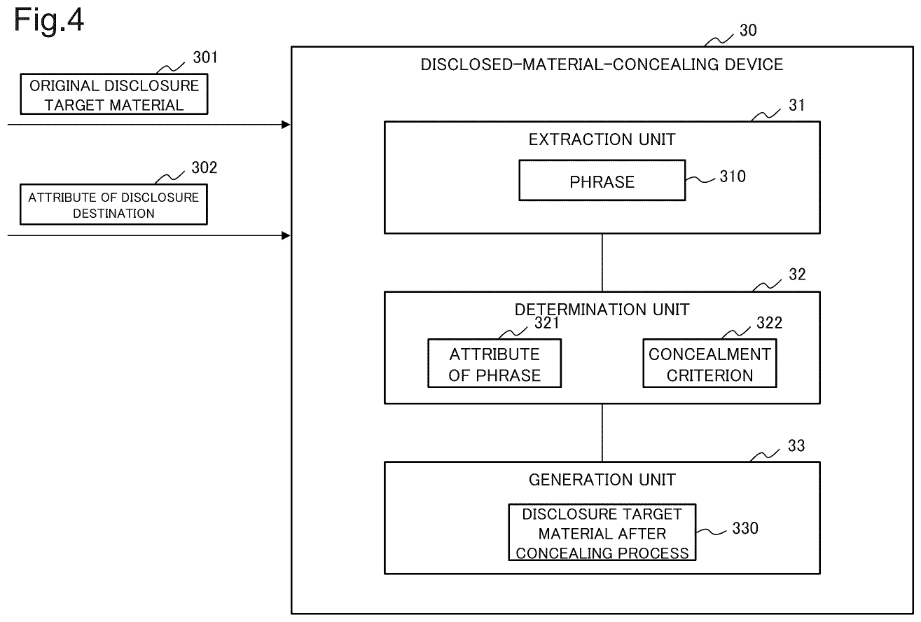

FIG. 4 is a block diagram illustrating a configuration of a disclosed-material-concealing device 30 according to a second example embodiment of the present invention. The disclosed-material-concealing device 30 includes an extraction unit 31, a determination unit 32, and a generation unit 33. However, the extraction unit 31, the determination unit 32, and the generation unit 33 are examples of an extraction means, a determination means, and a generation means in order.

That is, the extraction unit 31 extracts a phrase 310 from the original disclosure target material 301. The original disclosure target material 301 is, for example, a material similar to the original disclosure target material 101 according to the first example embodiment. For example, the extraction unit 31 operates similarly to the extraction unit 12 according to the first example embodiment.

The determination unit 32 determines whether to perform the concealing process on the phrase 310 based on the attribute 321 of the extracted phrase, the attribute 302 of the disclosure destination of the original disclosure target material 301, and the concealment criterion 322. However, the concealment criterion 322 represents a relationship among the attribute 321 of the phrase, the attribute 302 of the disclosure destination, and the necessity of performing the concealing process. The concealment criterion 322 is, for example, a criterion similar to the concealment criterion 163 according to the first example embodiment.

The attribute 321 of the phrase is, for example, an attribute similar to the attribute indicated by the attribute information 162 of the phrase according to the first example embodiment. The attribute 302 of the disclosure destination is, for example, an attribute similar to the attribute indicated by the attribute information 102 of the disclosure destination according to the first example embodiment. For example, the determination unit 32 operates similarly to the determination unit 13 according to the first example embodiment.

The generation unit 33 generates the disclosure target material 330 after the concealing process in which the concealing process has been performed on the phrase 310 determined to be subjected to the concealing process. The disclosure target material 330 after the concealing process is, for example, a material similar to the disclosure target material 164 after the concealing process according to the first example embodiment. For example, the generation unit 33 operates similarly to the generation unit 14 according to the first example embodiment.

The disclosed-material-concealing device 30 according to the present example embodiment can accurately conceal a certain phrase included in the material disclosed to the disclosure requesting side with high accuracy based on the relationship between the information and the disclosure requesting side. The reason therefor is that the disclosed-material-concealing device 30 conceals a phrase included in the material by using a concealment criterion 322 indicating a relationship among an attribute of a phrase included in the material, an attribute of a disclosure destination, and a necessity of performing the concealing process.

### Hardware Configuration Example

Each unit of the disclosed-material-concealing device 10 illustrated in FIG. 1 or the disclosed-material-concealing device 30 illustrated in FIG. 4 in each of the example embodiments described above can be achieved by dedicated hardware (HW) (electronic circuit). In FIGS. 1 and 4, at least the following configuration can be regarded as a functional (processing) unit (software module) of a software program.

### Storage Control Functions in

acquisition unit 11,
extraction units 12 and 31,
determination units 13 and 32,
generation units 14 and 33,
learning unit 15,
storage unit 16.

However, the division of each unit illustrated in these drawings is a configuration for convenience of description, and various configurations can be assumed at the time of implementation. An example of a hardware environment in this case will be described with reference to FIG. 5.

FIG. 5 is a diagram exemplarily describing a configuration of an information processing device 900 (computer) capable of achieving the disclosed-material-concealing device 10 according to the first example embodiment or the disclosed-material-concealing device 30 according to the second example embodiment of the present invention. That is, FIG. 5 illustrates a configuration of a computer (information processing device) capable of achieving the disclosed-material-concealing devices 10 and 30 illustrated in FIGS. 1 and 4, and illustrates a hardware environment capable of achieving each function in the example embodiments described above.

The information processing device 900 illustrated in FIG. 5 includes the following as components, but may not include some of the following components.
CPU (Central_Processing_Unit) 901,
ROM (Read_Only_Memory) 902,
RAM (Random_Access_Memory) 903,
hard disk (storage device) 904,
communication interface 905 with an external device,
bus 906 (communication line),
reader/writer 908 capable of reading and writing data stored in a recording medium 907 such as a CD-ROM (Compact_Disc_Read_Only_Memory),
input/output interface 909 such as a monitor, a speaker, or a keyboard.

That is, the information processing device 900 including the above components is a general computer to which these components are connected via the bus 906. The information processing device 900 may include a plurality of CPUs 901 or may include a CPU 901 with multi-cores. The information processing device 900 may include a graphical_processing_unit (GPU) (not illustrated) in addition to the CPU 901.

Then, the present invention described using the above-described example embodiments as an example supplies a computer program capable of achieving the following functions to the information processing device 900 illustrated in FIG. 5. The function is the above-described configuration in the block configuration diagram (FIGS. 1 and 4) referred to in the description of the example embodiment or the function of the flowchart (FIGS. 3A and 3B). Thereafter, the present invention is achieved by reading, interpreting, and executing the computer program on the CPU 901 of the hardware. The computer program supplied into the device may be stored in a readable/writable volatile memory (RAM 903) or a nonvolatile storage device such as the ROM 902 or the hard disk 904.

Furthermore, in the above case, a general procedure can be adopted at present as a method of supplying the computer program into the hardware. Examples of the procedure include, for example, a method of installing the program in the device via various recording media 907 such as a CD-ROM, a method of downloading the program from the outside via a communication line such as the Internet, and the like. In such a case, the present invention can be understood to be constituted by a code constituting the relevant computer program or the recording medium 907 storing the code.

The present invention has been described above using the above-described example embodiments as exemplary examples. However, the present invention is not limited to the above-described example embodiments. That is, the present invention can apply various aspects that can be understood by those skilled in the art within the scope of the present invention.

This application is based upon and claims the benefit of priority from Japanese Patent Application No. 2021-176074, filed on Oct. 28, 2021, the disclosure of which is incorporated herein in its entirety by reference.

### REFERENCE SIGNS LIST

10 Disclosed-material-concealing device
101 Original disclosure target material
102 Attribute information of disclosure destination
11 Acquisition unit
12 Extraction unit
13 Determination unit
14 Generation unit
15 Learning unit
16 Storage unit
161 Extraction criterion
162 Attribute information of phrase
163 Concealment criterion
164 Disclosure target material after concealing process
20 Management terminal device
200 Display screen
30 Disclosed-material-concealing device
301 Original disclosure target material
302 Attribute of disclosure destination
31 Extraction unit
310 Phrase
32 Determination unit
321 Attribute of phrase
322 Concealment criterion
33 Generation unit
330 Disclosure target material after concealing process
900 Information processing device
901 CPU
902 ROM
903 RAM
904 Hard disk (storage device)
905 Communication interface
906 Bus
907 Recording medium
908 Reader/writer
909 Input/output interface

What is claimed is:

1. A disclosed-material-concealing device comprising:
at least one memory storing a computer program; and
at least one processor configured to execute the computer program to
extract a phrase from original disclosure target material;
determine whether to perform a concealing process on the phrase based on an attribute of the extracted phrase, an attribute of a disclosure destination of the original disclosure target material, and a concealment criterion; and
generate a disclosure target material after the concealing process in which the concealing process has been performed on the phrase determined to be subjected to the concealing process;
wherein the concealment criterion represents a relationship among the attribute of the phrase, the attribute of the disclosure destination, and necessity of performing the concealing process.

2. The disclosed-material-concealing device according to claim 1, wherein
the attribute of the phrase represents a type of personal information or a date and time, and
the attribute of the disclosure destination represents a human relationship of the disclosure destination with respect to a person described in the original disclosure target material.

3. The disclosed-material-concealing device according to claim 2, wherein
the type of the personal information indicates at least one of a person's name, an age, an address, a contact information, an account number of a financial institution, a credit card number, a pension number, a resident record code, an Individual Number, a license number, a vehicle number of an automobile, an insurance card number, and a passport number, and
the human relationship represents at least one of a family member, a relative, a friend, a workplace being the same, and no acquaintance.

4. The disclosed-material-concealing device according to claim 1, wherein
the attribute of the phrase represents a type of organization information or a degree of confidentiality, and
the attribute of the disclosure destination represents a business relationship of the disclosure destination with respect to a creating department that has created the original disclosure target material.

5. The disclosed-material-concealing device according to claim 4, wherein
the type of the organization information indicates any of an organization name, a location of an organization, and a contact information,
the degree of confidentiality indicates organization secret or secret among authorized persons, and
the business relationship represents outside or inside of the organization to which the creating department belongs.

6. The disclosed-material-concealing device according to claim 1, wherein the processor is configured to execute the computer program to
generate or update the concealment criterion by learning a relationship among the attribute of the phrase, the attribute of the disclosure destination, and the necessity of performing the concealing process.

7. The disclosed-material-concealing device according to claim 6, wherein the processor is configured to execute the computer program to
generate or update the concealment criterion by accepting an input operation by a user who updates an attribute of the phrase.

8. The disclosed-material-concealing device according to claim 1, wherein the processor is configured to execute the computer program to
perform the concealing process by blacking out the phrase so as not to be visible or by abstracting the phrase.

9. A disclosed-material-concealing method by an information processing device, the method comprising:
extracting a phrase from original disclosure target material;
determining whether to perform a concealing process on the phrase based on attribute of the extracted phrase, attribute of a disclosure destination of the original disclosure target material, and a concealment criterion; and
generating a disclosure target material after the concealing process in which the concealing process has been performed on the phrase determined to be subjected to the concealing process, wherein
the concealment criterion represents a relationship among the attribute of the phrase, the attribute of the disclosure destination, and necessity of performing the concealing process.

10. A non-transitory computer-readable recording medium storing a disclosed-material-concealing program for causing a computer to execute:
an extraction process of extracting a phrase from original disclosure target material;
a determination process of determining whether to perform a concealing process on the phrase based on attribute of the extracted phrase, attribute of a disclosure destination of the original disclosure target material, and a concealment criterion; and
a generation process of generating a disclosure target material after the concealing process in which the concealing process has been performed on the phrase determined to be subjected to the concealing process, wherein
the concealment criterion represents a relationship among the attribute of the phrase, the attribute of the disclosure destination, and necessity of performing the concealing process.
